(19) United States
(12) Patent Application Publication
(10) Pub. No.: US 2026/0141913 A1
(43) Pub. Date: May 21, 2026

(54) ENHANCED PROCESSING OF SPATIAL AUDIO BASED ON SEPARATED AUDIO CONTENT AND ASSOCIATED DIRECTION INFORMATION, AND RELATED DEVICES, METHODS AND COMPUTER PROGRAMS

(71) Applicant: Nokia Technologies Oy, Espoo (FI)

(72) Inventors: Juha Tapio VILKAMO, Espoo (FI); Mikko-Ville LAITINEN, Espoo (FI)

(21) Appl. No.: 19/383,292

(22) Filed: Nov. 7, 2025

(30) Foreign Application Priority Data
Nov. 15, 2024 (FI) 20246335

(51) Int. Cl. G10L 25/03; G10L 21/0272

(52) U.S. Cl. CPC G10L 25/03; G10L 21/0272

(57) ABSTRACT

Devices, methods and computer programs for enhanced processing of spatial audio based on separated audio content and associated direction information are disclosed. At least some example embodiments may allow improving spatial stability of audio capture and rendering, because a separated audio object is not affected by other sounds present, and because the separated audio object does not affect the spatial metadata analysis of the remainder sound.

### TECHNICAL FIELD

The disclosure relates generally to audio processing and, more particularly but not exclusively, to enhanced processing of spatial audio based on separated audio content and associated direction information, as well as related devices, methods and computer programs.

### BACKGROUND

Recently, enabling spatial audio communication and teleconferencing on mobile devices has been under development. Parametric spatial audio (transport audio signal(s) and spatial metadata) may be determined and coded from multiple microphones (e.g., a microphone array on a mobile phone) in order to provide immersive audio communication (such as spatial calls and teleconferences) using normal user equipment, such as normal mobile phones.

However, while the spatial metadata may be determined based on audio signals from the microphones, it is known that robust metadata determination that would work well in all sound scenes is difficult, especially when the microphone arrangement is a modest one, such as the ones typically integrated in mobile phones. In other words, the analysed spatial metadata may be unstable in some sound situations. When this metadata is used for spatial audio synthesis, the result may be perceived spatially unstable, at least occasionally, which the listener perceives as distracting and adverse.

As a practical example, if there is a talker at one direction with other sound elements present (e.g., passing cars) at other directions, parts of the talker's voice may move positionally (e.g., towards the other sound elements) when these other sound elements are active. Human hearing is critical to such variations especially when it comes to speech sounds.

Accordingly, at least in some situations, it may be beneficial to be able to enhance or improve spatial audio processing techniques.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of a user device comprises at least one processor, and at least one memory storing instructions that, when executed by the at least one processor, cause the user device at least to obtain at least two microphone signals that represent spatial audio that includes at least intermittently audio content generated by at least one audio content source. The at least two microphone signals have been captured with at least two microphones. The instructions, when executed by the at least one processor, further cause the user device at least to separate, at least partly, the audio content generated by the at least one audio content source from the obtained at least two microphone signals. The instructions, when executed by the at least one processor, further cause the user device at least to determine direction information for the at least one audio content source. The direction information comprises information about a spatial direction which the audio content generated by the at least one audio content source originates from with respect to the at least two microphones. The instructions, when executed by the at least one processor, further cause the user device at least to perform one or more processing tasks based on the separated audio content and the determined direction information to generate an encoded spatial audio bit stream.

In an example embodiment, alternatively or in addition to the above-described example embodiments, the one or more processing tasks comprise generating one or more audio objects from the separated audio content based on the determined direction information. Each audio object comprises an audio signal with at least one of an associated direction parameter or an associated position parameter.

In an example embodiment, alternatively or in addition to the above-described example embodiments, the one or more processing tasks further comprise generating an auxiliary spatial audio bit stream from the obtained at least two microphone signals substantially without the audio content.

In an example embodiment, alternatively or in addition to the above-described example embodiments, the auxiliary spatial audio bit stream comprises a metadata-assisted spatial audio, MASA, stream.

In an example embodiment, alternatively or in addition to the above-described example embodiments, the one or more processing tasks further comprise generating the spatial audio bit stream based on the generated auxiliary audio bit stream and the generated one or more audio objects.

In an example embodiment, alternatively or in addition to the above-described example embodiments, the spatial audio bit stream comprises an objects with metadata-assisted spatial audio, OMASA, stream.

In an example embodiment, alternatively or in addition to the above-described example embodiments, the one or more processing tasks further comprise encoding the generated spatial audio bit stream with one or more audio signals of at least one audio object of the generated one or more audio objects encoded separately from one or more audio signals of the generated auxiliary audio bit stream.

In an example embodiment, alternatively or in addition to the above-described example embodiments, the encoding of the generated spatial audio bit stream comprises adaptively adjusting a bit allocation within the generated spatial audio bit stream between the at least one audio object of the generated one or more audio objects and the generated auxiliary audio bit stream.

In an example embodiment, alternatively or in addition to the above-described example embodiments, the separation of the audio content comprises estimating a speech time-frequency signal having multiple channels comprising the audio content.

In an example embodiment, alternatively or in addition to the above-described example embodiments, the separation of the audio content further comprises estimating a speech time-frequency signal having a single channel comprising the audio content.

In an example embodiment, alternatively or in addition to the above-described example embodiments, the separation of the audio content further comprises estimating speech steering data indicating an estimated response of the audio content to the at least two microphones.

In an example embodiment, alternatively or in addition to the above-described example embodiments, the separation of the audio content further comprises estimating a microphone time-frequency signal with speech removed representing a remainder signal without the audio content.

In an example embodiment, alternatively or in addition to the above-described example embodiments, the determination of the direction information is performed based on the estimated speech time-frequency signal and the estimated speech steering data.

In an example embodiment, alternatively or in addition to the above-described example embodiments, the information about the spatial direction comprises at least one of direction of arrival, DOA, information of the spatial direction or a direct-to-total energy ratio of the spatial direction. The direct-to-total energy ratio indicates how much of the energy in a frequency resource is directional energy coming from the spatial direction.

In an example embodiment, alternatively or in addition to the above-described example embodiments, the determination of the direction information comprises temporal averaging of at least energy-weighted sums of the DOA information over multiple frequencies.

In an example embodiment, alternatively or in addition to the above-described example embodiments, the audio content comprises speech.

An example embodiment of a method comprises obtaining, by a user device, at least two microphone signals that represent spatial audio that includes at least intermittently audio content generated by at least one audio content source. The at least two microphone signals have been captured with at least two microphones. The method further comprises separating, by the user device, at least partly the audio content generated by the at least one audio content source from the obtained at least two microphone signals. The method further comprises determining, by the user device, direction information for the at least one audio content source. The direction information comprises information about a spatial direction which the audio content generated by the at least one audio content source originates from with respect to the at least two microphones. The method further comprises performing, by the user device, one or more processing tasks based on the separated audio content and the determined direction information to generate an encoded spatial audio bit stream.

An example embodiment of an apparatus comprises means for carrying out a method according to any of the above-described example embodiments.

An example embodiment of a computer program comprises instructions for causing a user device to perform at least the following: obtaining at least two microphone signals representing spatial audio including at least intermittently audio content generated by at least one audio content source, the at least two microphone signals captured with at least two microphones; separating, at least partly, the audio content generated by the at least one audio content source from the obtained at least two microphone signals; determining direction information for the at least one audio content source, the direction information comprising information about a spatial direction which the audio content generated by the at least one audio content source originates from with respect to the at least two microphones; and performing one or more processing tasks based on the separated audio content and the determined direction information to generate an encoded spatial audio bit stream.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 shows an example embodiment of the subject matter described herein illustrating an example system, where various embodiments of the present disclosure may be implemented;

FIG. 2A shows an example embodiment of the subject matter described herein illustrating a user device, where various embodiments of the present disclosure may be implemented;

FIG. 2B shows an example embodiment of the subject matter described herein illustrating another user device, where various embodiments of the present disclosure may be implemented;

FIG. 3 shows an example embodiment of the subject matter described herein illustrating an end-to-end spatial audio processing arrangement;

FIG. 4 shows an example embodiment of the subject matter described herein illustrating operation of an example implementation of a front-end of FIG. 3;

FIG. 5 shows an example embodiment of the subject matter described herein illustrating operation of an example implementation of a speech separator of FIG. 4;

FIG. 6 shows an example embodiment of the subject matter described herein illustrating operation of an example implementation of an object direction determiner of FIG. 4;

FIG. 7 shows an example embodiment of the subject matter described herein illustrating operation of another example implementation of a front-end of FIG. 3;

FIG. 8 shows an example embodiment of the subject matter described herein illustrating operation of an example implementation of an encoder of FIG. 3;

FIG. 9 shows an example embodiment of the subject matter described herein illustrating operation of another example implementation of an encoder of FIG. 3;

FIG. 10 shows an example embodiment of the subject matter described herein illustrating operation of an example implementation of a decoder of FIG. 3;

FIG. 11 shows an example embodiment of the subject matter described herein illustrating operation of an example implementation of a spatial synthesizer of FIG. 10;

FIG. 12 shows an example embodiment of the subject matter described herein illustrating an example network structure for use in machine learning training; and

FIG. 13 shows an example embodiment of the subject matter described herein illustrating a method for the user device.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

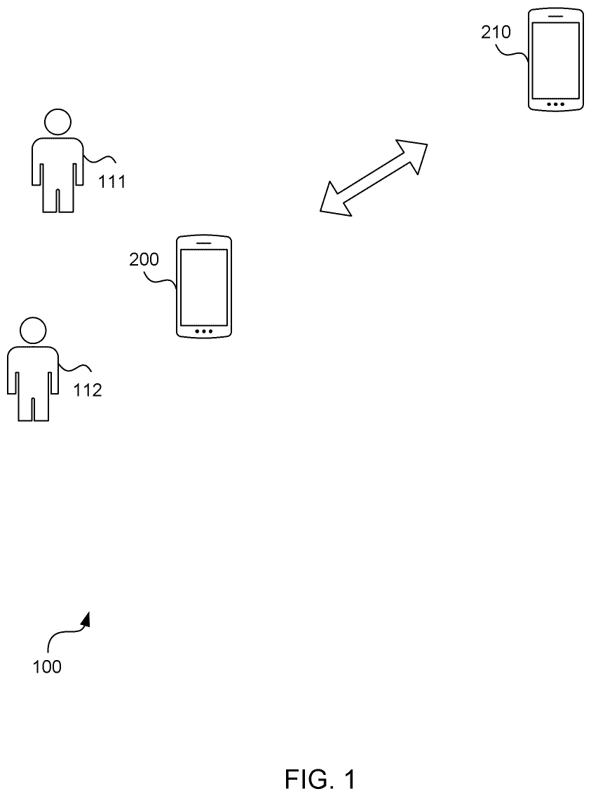

FIG. 1 illustrates example system 100, where various embodiments of the present disclosure may be implemented. An example representation of system 100 is shown depicting a user device 200 and a user device 210 communicating with each other, e.g., to provide audio communication, for example, a spatial audio communication and/or teleconferencing service. The user device 200 is in a first location (e.g., a first room) and the user device 210 is in a second location (e.g., a second room). Herein, user device 200 is the calling device and user device 210 is the called device. Audio content sources for user device 200 may comprise, e.g., users/talkers associated with user device 200 and talking, e.g., in a spatial audio communication and/or teleconferencing service.

The user device 200 (and the user device 210) may comprise, e.g., a mobile communication device, a mobile phone, a smartphone, a tablet computer, a smart watch, smart glasses, a smart audio headset, an AR/VR/XR (augmented reality, virtual reality, extended reality) device, any hand-held, portable and/or wearable device, a television, a vehicle infotainment unit, or any combination thereof. User device 200 may also be referred to as a user equipment (UE).

As will be described in more detail below, user device 200 may process microphone signals to a bitstream. The bitstream may be provided via a transceiver to remote user device 210 to be decoded and rendered. User device 200 may also have a user interface with which the processing may be controlled. User device 200 may also be performing other operations, such as processing related to video communication.

As will be described in more detail below, user device 210 may receive the bitstream from remote user device 200 via a transceiver and process the bitstream to spatial audio output. The spatial audio output may be, e.g., a binaural sound that is provided via wired or wireless connection to be reproduced over headphones. User device 210 may also have a user interface with which the processing may be controlled, for example, the object positions or relative levels may be altered.

In the following, various concepts and terms that may be relevant to at least some example embodiments will be discussed.

Immersive voice and audio services (IVAS) codec is an extension of 3rd generation partnership project (3GPP) enhanced voice services (EVS) codec and intended for new immersive voice and audio services over fourth generation/fifth generation 4G/5G mobile networks. Such immersive services may include, e.g., immersive voice and audio for virtual reality (VR). IVAS may handle encoding, decoding, and/or rendering of speech, music, and generic audio, for example. IVAS may support a variety of input formats, such as channel-based, scene-based, and object-based inputs, as well as MASA (metadata-assisted spatial audio) inputs. IVAS may operate with low latency to enable conversational services as well as support high error robustness under various transmission conditions.

The metadata-assisted spatial audio (MASA) is one of the input formats supported by IVAS. MASA may use audio signal(s) together with corresponding spatial metadata (containing, e.g., directions and direct-to-total energy ratios in frequency bands). A MASA stream may, e.g., be obtained by capturing spatial audio with microphones of, e.g., a mobile device, where the set of spatial metadata may be estimated based on the microphone signals. A MASA stream may be obtained also from other sources, such as spatial audio microphones, studio mixes (e.g., a 5.1 multichannel mix) or other content by means of a suitable format conversion.

MASA spatial metadata may have values available for each time-frequency tile (TF-tile), with 24 frequency bands and 4 temporal sub-frames in each frame. The frame size in IVAS is 20 milliseconds (ms), and thus a temporal sub-frame is 5 ms. In addition, MASA supports 1 or 2 directions for each time-frequency tile, i.e., there may be 1 or 2 direction indices, a direct-to-total energy ratio, and spread coherence parameters for each time-frequency tile.

IVAS may also support audio objects (independent streams with metadata, ISM) as input. For example, an audio object may comprise, per each object, an audio signal and associated metadata (e.g., the direction of the object).

Furthermore, IVAS may support a combined format input of audio objects and MASA streams. This combination is referred to as ‘objects with metadata-assisted spatial audio’ (OMASA).

In the following, various example embodiments will be discussed. At least some of these example embodiments described herein may allow enhanced processing of spatial audio based on separated audio content and associated direction information.

Furthermore, at least some of the example embodiments described herein may allow improving spatial stability of audio capture and rendering, because a separated audio object is not affected by other sounds present, and because the separated audio object does not affect the spatial metadata analysis of the remainder sound. For example, in a situation having speech combined with surrounding ambient sounds, at least some of the example embodiments described herein may allow preventing or at least mitigating surrounding ambient sounds to cause fluctuation in the direction of the speech, which would be perceived as an artefact, as speech should be perceived originating stably from a single direction instead of a fluctuating direction (which could also be fluctuating in a frequency-dependent fashion, making it even more unnatural).

Furthermore, at least some of the example embodiments described herein may allow increasing immersive voice coding efficiency (thus enabling better quality and/or lower bitrate) since the separated speech portion can be encoded with a voice-optimized coding mode, and the remainder can be encoded with a general-purpose optimized coding mode.

Furthermore, at least some of the example embodiments described herein may allow receiver side control of proportions (and spatialization) of speech, and thus ambience sound may be enabled in an immersive voice call. For example, at least some of the example embodiments described herein may allow for the receiver side to be able to reposition a talker, and/or to configure relative levels of speech and other sounds.

Furthermore, at least some of the example embodiments described herein may not require perfect source separation for speech, as sounds may be reproduced as a part of an object part or a ‘metadata-assisted spatial audio’ (MASA) part. E.g., if speech partially leaks to the MASA part, it may still be reproduced from roughly the correct direction based on the parametric spatial metadata. Similarly, if some ambience (that is, non-speech part) is leaked to the object part, it may be still reproduced. Thus, the disclosure may be reliably used with everyday devices, such as normal mobile phones, rather than requiring expensive specialized teleconferencing equipment.

Furthermore, at least some of the example embodiments described herein may allow a practical method for creating an OMASA (objects and MASA) input stream for a 3GPP IVAS codec using a normal mobile phone without any additional accessories needed. Without the disclosure, additional microphones (e.g., close microphones) would be needed for creating the OMASA stream.

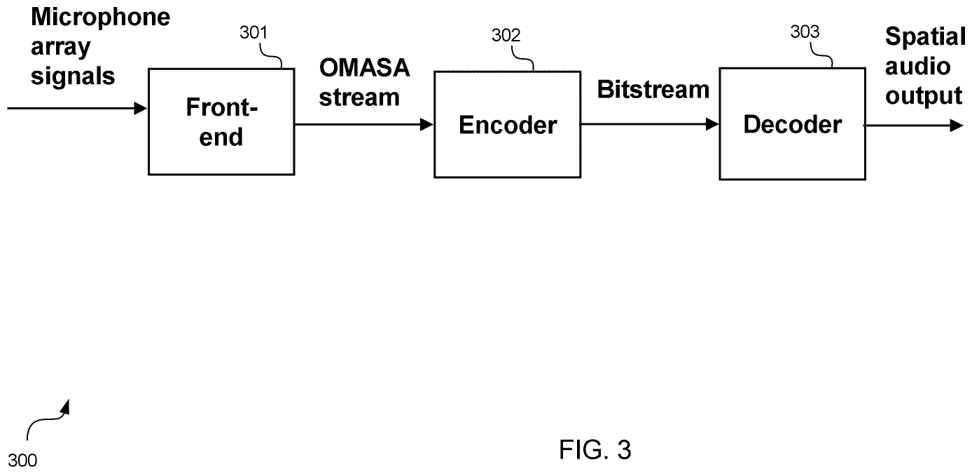

Diagram 300 of FIG. 3 illustrates an end-to-end spatial audio processing arrangement.

Input comprises microphone signals, e.g., from at least two microphones 206A, 206B integrated to user device 200, which may be forwarded to front-end 301. Front-end 301 may determine an OMASA stream, which may comprise a MASA stream (e.g., MASA transport audio signals and MASA metadata) and an object audio stream (e.g., object signals and object directions). The OMASA stream may be forwarded to encoder 302, which may, e.g., comprise an IVAS encoder. Encoder 302 may encode the OMASA stream and form a bitstream, which may be passed to decoder 303, which may, e.g., comprise an IVAS decoder. Decoder 303 may then decode the bitstream and render spatial audio output. The spatial audio output may, e.g., comprise binaural audio signals. At least in some configurations, front-end 301 and encoder 302 for processing given microphone signals to spatial audio output may reside on one apparatus, and decoder 303 for the same processing may reside on another apparatus.

Even though in the following user device 200 is described as including the functionalities of front-end 301 and encoder 302, and user device 210 is described as including the functionalities of decoder 303 for the sake of simplicity, one or both of user device 200 and user device 210 may comprise the functionalities of front-end 301, encoder 302 and decoder 303.

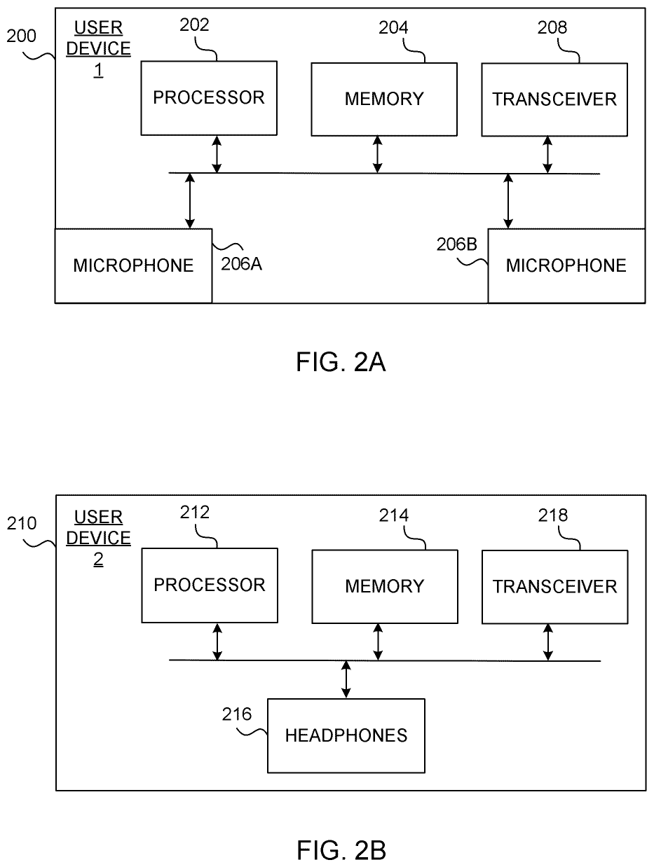

FIG. 2A is a block diagram of user device 200, in accordance with an example embodiment.

User device 200 comprises one or more processors 202 and one or more memories 204 that comprise computer program code. User device 200 may also comprise at least two internal microphones 206A, 206B, such as a microphone array. Alternatively/additionally, at least some of at least two microphones 206A, 206B may be external to user device 200 and connected to user device 200 via wireless or wired connection. Typically, user device 200 may comprise two or three internal and/or external microphones but the disclosure is not limited to these examples.

User device 200 may also include (or be connected to) other elements, such as transceiver 208 configured to enable user device 200 to transmit and/or receive information to/from other devices, as well as other elements not shown in FIG. 2A (e.g., headphones or the like). In one example, user device 200 may use transceiver 208 to transmit or receive signalling information and data in accordance with at least one cellular communication protocol. Transceiver 208 may be configured to provide at least one wireless radio connection, such as for example a 3GPP mobile broadband connection (e.g., 5G or 6G). Transceiver 208 may comprise, or be configured to be coupled to, at least one antenna to transmit and/or receive radio frequency signals.

Although user device 200 is depicted to include only one processor 202, user device 200 may include more processors. In an embodiment, memory 204 is capable of storing instructions, such as an operating system and/or various applications. Furthermore, memory 204 may include a storage that may be used to store, e.g., at least some of the information and data used in the disclosed embodiments.

Furthermore, processor 202 is capable of executing the stored instructions. In an embodiment, processor 202 may be embodied as a multi-core processor, a single core processor, or a combination of one or more multi-core processors and one or more single core processors. For example, processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network (NN) chip, an artificial intelligence (AI) accelerator, a tensor processing unit (TPU), a neural processing unit (NPU), or the like. In an embodiment, processor 202 may be configured to execute hard-coded functionality. In an embodiment, processor 202 is embodied as an executor of software instructions, wherein the instructions may specifically configure processor 202 to perform the algorithms and/or operations described herein when the instructions are executed.

Memory 204 may be embodied as one or more volatile memory devices, one or more non-volatile memory devices, and/or a combination of one or more volatile memory devices and non-volatile memory devices. For example, memory 204 may be embodied as semiconductor memories (such as mask ROM, PROM (programmable ROM), EPROM (erasable PROM), flash ROM, RAM (random access memory), etc.

When executed by at least one processor 202, instructions stored in at least one memory 204 cause user device 200 at least to obtain at least two microphone signals that represent spatial audio that includes at least intermittently audio content generated by at least one audio content source 111, 112.

For example, the audio content may comprise speech generated by a person representing at least one audio content source 111, 112. However, the disclosure is not limited to speech as audio content. Instead, the audio content may comprise any other audio type originated from a source type, such as sounds from a guitar or any other musical instrument acting as an audio source.

The at least two microphone signals have been captured with at least two microphones 206A, 206B.

The instructions, when executed by at least one processor 202, further cause user device 200 at least to separate, at least partly, the audio content generated by at least one audio content source 111, 112 from the obtained at least two microphone signals.

For example, the separation of the audio content may comprise estimating a speech time-frequency signal having multiple channels comprising the audio content. Alternatively, the separation of the audio content may comprise estimating a speech time-frequency signal having a single channel comprising the audio content.

At least in some embodiments, the separation of the audio content may further comprise estimating speech steering data that indicates an estimated response of the audio content to at least two microphones 206A, 206B. At least in some embodiments, the separation of the audio content may further comprise estimating a microphone time-frequency signal with speech removed representing a remainder signal without the audio content.

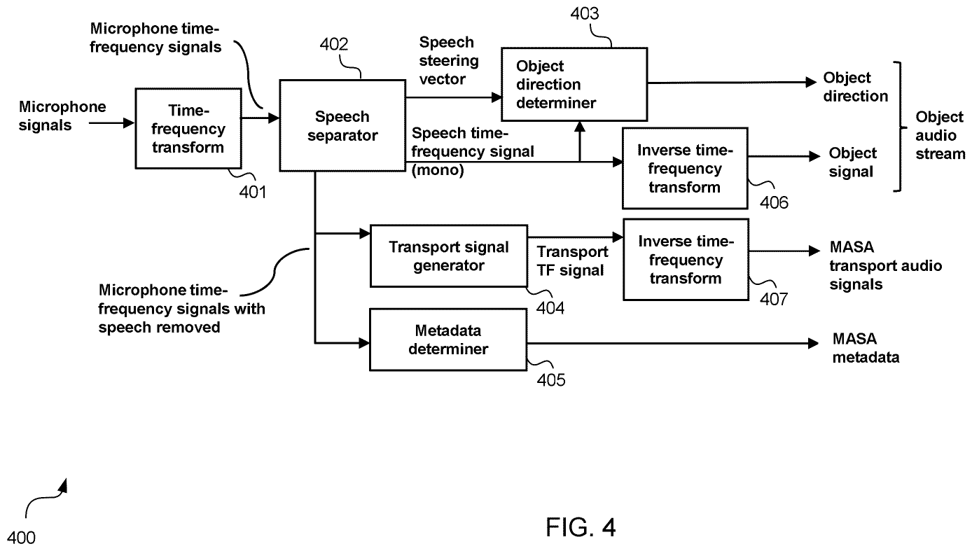

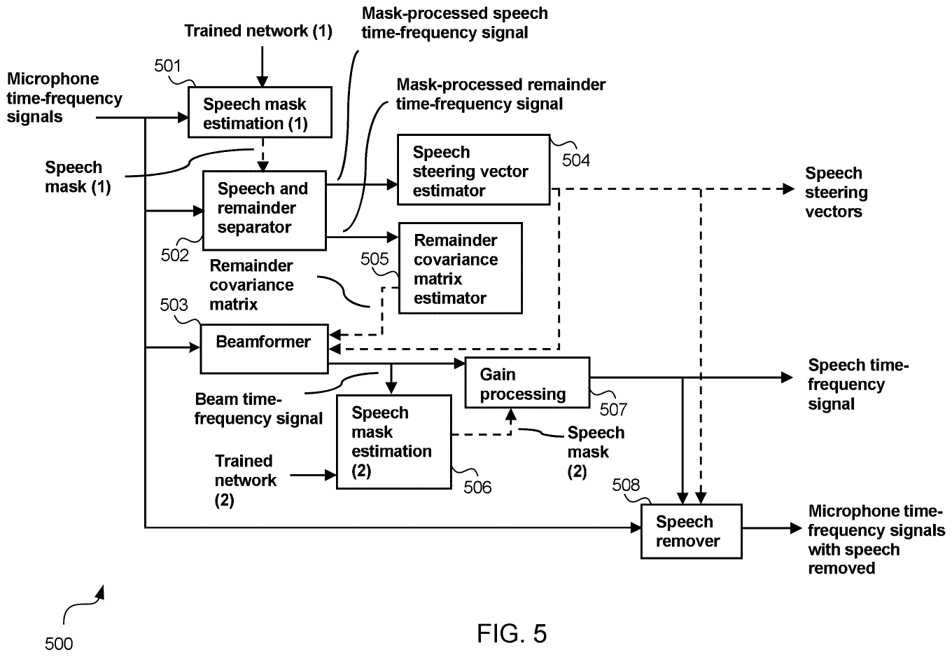

Examples of the above separation of the audio content are described in more detail below in connection with diagram 400 (including speech separator 402) of FIG. 4 and diagram 500 of FIG. 5, for example.

The instructions, when executed by at least one processor 202, further cause user device 200 at least to determine direction information for at least one audio content source 111, 112.

At least in some embodiments, the determination of the direction information may be performed based on the estimated speech time-frequency signal and the estimated speech steering data. At least in some embodiments, the determination of the direction information may be performed based on the speech time-frequency signal having multiple channels comprising the audio content. That is, as will be described in more detail below, at least in some embodiments, mono-speech and steering vectors may be used, but alternatively multi-channel speech having the equivalent information in a combined form may be used.

The direction information comprises information about a spatial direction which the audio content generated by at least one audio content source 111, 112 originates from with respect to at least two microphones 206A, 206B. For example, the information about the spatial direction may comprise direction of arrival (DOA) information of the spatial direction and/or a direct-to-total energy ratio of the spatial direction, direction-of-propagation information, direction index information, spatial position information, etc. The direct-to-total energy ratio may indicate how much of the energy in a frequency resource is directional energy coming from the spatial direction. At least in some embodiments, the direct-to-total energy ratio may be in various equivalent or closely related formats, such as ambience-to-total ratios, index tables, etc. At least in some embodiments, the determination of the direction information may comprise temporal averaging of at least energy-weighted sums of the DOA information over multiple frequencies.

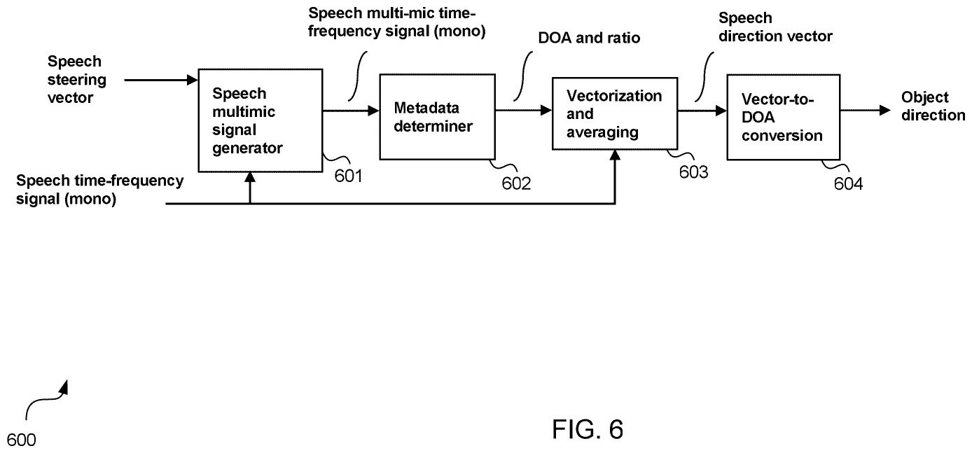

Examples of the above determination of the direction information are described in more detail below in connection with diagram 400 (including object direction determiner 403) of FIG. 4 and diagram 600 of FIG. 6, for example.

The instructions, when executed by at least one processor 202, further cause user device 200 at least to perform one or more processing tasks based on the separated audio content and the determined direction information, in order to generate an encoded spatial audio bit stream.

At least in some embodiments, the one or more processing tasks may comprise generating one or more audio objects from the separated audio content based on the determined direction information. Each audio object may comprise an audio signal with an associated direction parameter and/or an associated position parameter.

At least in some embodiments, the one or more processing tasks may further comprise generating an auxiliary spatial audio bit stream from the obtained at least two microphone signals substantially without the audio content. For example, the auxiliary spatial audio bit stream may comprise a ‘metadata-assisted spatial audio’ (MASA) stream.

At least in some embodiments, the one or more processing tasks may further comprise generating the spatial audio bit stream based on the generated auxiliary audio bit stream and the generated one or more audio objects. For example, the spatial audio bit stream may comprise an ‘objects with metadata-assisted spatial audio’ (OMASA) stream.

At least in some embodiments, the one or more processing tasks may further comprise encoding the generated spatial audio bit stream with one or more audio signals of at least one audio object of the generated one or more audio objects encoded separately from one or more audio signals of the generated auxiliary audio bit stream. For example, the encoding of the generated spatial audio bit stream may comprise adaptively adjusting a bit allocation within the generated spatial audio bit stream between the at least one audio object of the generated one or more audio objects and the generated auxiliary audio bit stream.

In the following, examples of above-described functionalities of user device 200 (implemented as front-end 301) are described in more detail using speech as an example of audio content.

Diagram 400 of FIG. 4 illustrates operation of an example implementation of front-end 301 of FIG. 3. Functionalities (including, e.g., time-frequency transform 401, speech separator 402, object direction determiner 403, transport signal generator 404, metadata determiner 405, inverse time-frequency transform 406, and/or time-frequency transform 407) of diagram 400 may, for example, be carried out by at least one processor 202 and at least one memory 204.

As shown in FIG. 4, microphone signals from microphones 206A, 206B may first be provided to time-frequency transform 401, which may convert them to microphone time-frequency signals. As an example, the transform may be a short-time Fourier transform with a hop-size of 960 samples and a fast Fourier transform (FFT) size of 1920 samples, using a square-root of a Hann window as an analysis window. The microphone time-frequency signals may be provided to speech separator 402.

The operation of speech separator 402 is detailed further below. In short, it may use a machine learning based solution in estimating the speech time-frequency signal that may have a single channel comprising the speech within the microphone signals. It may also provide a speech steering vector that is an estimated response of the speech sound to the microphone arrangement. Furthermore, speech separator 402 may also formulate microphone time-frequency signals with speech removed, which is a remainder signal that comprises all other sounds except speech.

The microphone time-frequency signals with speech removed may be provided to transport signal generator 404 and metadata determiner 405.

Transport signal generator 404 may generate a transport time-frequency signal, which may have one or more channels (e.g., two channels, i.e., a stereo signal), based on the microphone time-frequency signals with speech removed. If the microphone(s) 206A, 206B are in user device 200 in a landscape orientation, the generation of the transport time-frequency signal may include selecting the two channels that correspond to the microphones at the left and right edges of user device 200. In some configurations, the processing may involve beamforming to left and right directions. For example, if the microphone signals are based on a set of cardioid microphones closely placed, or if the microphone signals are a first-order Ambisonic signal, transport signal generator 404 may generate cardioid-shaped beams towards left and right directions to generate the transport time-frequency audio signal.

The transport time-frequency signal may then be provided to inverse time-frequency transform 407, which may apply an inverse transform corresponding to the time-frequency transform, in this case an inverse short-time Fourier transform (STFT) with same configuration parameters as the applied STFT. The output may comprise MASA transport audio signals.

Metadata determiner 405 may receive the microphone time-frequency signals with speech removed, and generate spatial metadata based on it. A suitable method for the determining of the metadata may depend on the microphone arrangement. For example, if user device 200 is a smart phone with two or more microphones 206A, 206B, a delay analysis between the microphones may be used to determine a direction parameter in frequency bands, and correlation analysis may be used to determine the direct-to-total energy ratio for that direction. If the microphone signals are a first-order Ambisonic (FOA) signal, or if they can be converted to a FOA signal, metadata determiner 405 may use methods that are based on directional audio coding (DirAC) to determine direction and ratio parameters. The analysed metadata directions and ratios may form the MASA metadata. Other MASA parameters may be set to zero or to other suitable values (e.g., a diffuse-to-total energy ratio may be obtained as one minus the direct-to-total energy ratio). The determined MASA metadata may be outputted from block 405.

The determined speech time-frequency signal may be forwarded to the inverse time-frequency transform 406. Inverse time-frequency transform 406 may apply an inverse transform corresponding to the time-frequency transform, in this case an inverse STFT with same configuration parameters as the applied STFT, and output an object signal.

The speech time-frequency signal may also be provided to object direction determiner 403, alongside a speech steering vector. Based on them, object direction determiner 403 may generate an object direction. The operation of object direction determiner 403 is described in more detail further below. This object direction may then form the object audio stream together with the object signal.

The above description of front-end 301 includes operators needed to implement the disclosure. However, a front-end may further include additional audio processing functionalities, such as equalization, automatic gain control, limiter, wind noise removal, and/or microphone noise removal, etc.

Diagram 500 of FIG. 5 illustrates operation of an example implementation of speech separator 402 of FIG. 4. Functionalities (including, e.g., speech mask estimation (1) 501, speech and remainder separator 502, beamformer 503, speech steering vector estimator 504, remainder covariance matrix estimator 505, speech mask estimation (2) 506, gain processing 507, and/or speech remover 508) of diagram 500 may, for example, be carried out by at least one processor 202 and at least one memory 204.

First, the microphone time-frequency signals may be provided to speech mask estimator 501 that may use a trained network (1). In the present example, the trained network (1) and trained network (2) are the same trained network but applied two times separately. However, in some embodiments these networks may be different, or differently trained. The structure, training and the inference of this trained network is detailed below.

The operation of speech mask estimation 501 is described in detail further below where training and inference with a machine learning (ML) model is described. In short, block 501 may involve usage of a trained network to estimate a speech mask, denoted O(n, f), based on data that speech mask estimation block 501 receives. In the present example, n denotes a temporal index and f is a frequency index that corresponds to a frequency range so that one frequency index f corresponds to one or more frequency bins b of an applied time-frequency transform. The output of first speech mask estimation (1) block 501 is speech mask (1) and is denoted as O₁(n, f).

Speech and remainder separator 502 may receive the speech mask (1) O₁(n, f) and microphone time-frequency signal S(n, b, i), where i is an audio channel index, and generate a mask-processed speech time-frequency signal, e.g., by:

$${S}_{speechM} ( n , b , i ) = S ( n , b , i ) {O}_{1} ( n , f )$$

where frequency index f is the one where bin b resides. Speech and remainder separator 502 may also generate a mask-processed remainder time frequency signal, e.g., by:

$${S}_{remainderM} ( n , b , i ) = S ( n , b , i ) ( 1 - {O}_{1} ( n , f ) )$$

where frequency index f is the one where bin b resides. These signals may be output by speech and remainder separator 502.

Speech steering vector estimator 504 may receive the mask-processed speech time-frequency signal and estimate a steering vector based on it. First, a speech covariance matrix may be formulated, e.g., by:

$${C}_{s} ( n , b ) = ( 1 - {γ}_{s} ) {s}_{speechM} ( n , b ) {s}_{speechM}^{H} ( n , b ) + {γ}_{s} {C}_{s} ( n - 1 , b )$$

where γₛ is a temporal smoothing coefficient (having, e.g., the value of 0.8), Cₛ(0, b) may be a matrix of zeros, and s_{speechM}(n, b) is a column vector having the channels of signal S_{speechM}(n, b, i) at its rows. Then, speech steering vector estimator 504 may apply an eigen decomposition to Cₛ(n, b), and obtain an eigenvector u(n, b) that corresponds to a largest eigenvalue. Then, the eigenvector may be normalized with respect to its first channel, e.g., by:

$$v ( n , b ) = \frac{u ( n , b )}{U ( n , b , 1 )}$$

where U(n, b, 1) is the first-row entry of u(n, b). Vector v(n, b) may then be the estimated steering vector of the speech signal (i.e., the speech steering vector) and may contain the steering vector values V(n, b, i) at its rows. The speech steering vector may be output by speech steering vector estimator 504. Here, both the vector form v(n, b) as well as the entry form V(n, b, i) may be utilized to denote the speech steering vector.

It is to be noted that the above normalization is provided as an example only. In some embodiments, the steering vectors may be differently normalized or not normalized.

Remainder covariance matrix estimator 505 may receive the mask-processed remainder time-frequency signal and estimate a covariance matrix based on it, e.g., by:

$${C}_{r} ( n , b ) = ( 1 - {γ}_{r} ) {s}_{remainderM} ( n , b ) {s}_{remainderM}^{H} ( n , b ) + {γ}_{r} {C}_{r} ( n - 1 , b )$$

where γᵣ is a temporal smoothing coefficient (having, e.g., a value of 0.8), Cᵣ(0, b) may be a matrix of zeros and S_{remainderM}(n, b) is a column vector having the channels of signal S_{remainderM}(n, b, i) at its rows. Remainder covariance matrix estimator 505 may output the remainder covariance matrix Cᵣ(n, b).

Beamformer 503 may receive the microphone time-frequency signals, the speech steering vectors and the remainder covariance matrix and perform beamforming. Beamformer 503 may apply for example minimum variance distortionless response (MVDR) to obtain beamforming weights:

$$w ( n , b ) = {C}_{r}^{- 1} ( n , b ) \frac{v ( n , b )}{{v}^{H} ( n , b ) {C}_{r}^{- 1} ( n , b ) v ( n , b )}$$

Then, beamformer 503 may apply the beamforming weights to the time-frequency signal, e.g., by:

$${S}_{beam} ( n , b ) = {w}^{H} ( n , b ) s ( n , b )$$

where s(n, b) is a column vector having the channels of signal S(n, b, i) at its rows. Beamformer 503 may then provide the beam time-frequency signal S_{beam}(n, b) as its output.

Speech mask estimation (2) block 506 may receive the beam time-frequency signal S_{beam}(n, b) and use the trained network (2). As described previously, the trained network (2) and trained network (1) may be the same trained network. The operation of speech mask estimator (2) 506 may be the same as that of speech mask estimation (1) 501, except for that the input signal may be different and it may have only one channel. Speech mask estimation (2) 506 may provide speech mask (2) O₂(n, f) as its output.

Gain processing block 507 may receive the beam time-frequency signal S_{beam}(n, b) and the speech mask (2) O₂(n, f). It may process the beam time-frequency signal with the mask in the same way as speech and remainder separator 502 processed the time-frequency signals with speech mask (1) when generating the mask-processed speech time-frequency signal:

$${S}_{speech} ( n , b ) = {S}_{beam} ( n , b ) {O}_{2} ( n , f ) .$$

The gain-processed beam time-frequency signal may then be the speech time-frequency signal S_{speech}(n, b).

The speech steering vectors V(n, b, i), speech time-frequency signal S_{speech}(n, b) and the microphone time-frequency signals S(n, b, i) may be provided to speech remover 508. It performs the removal of the speech from the microphone time-frequency signals, e.g., by:

$${S}_{remainder} ( n , b , i ) = S ( n , b , i ) - V ( n , b , i ) {S}_{speech} ( n , b )$$

The S_{remainder}(n, b, i) may then be the microphone time-frequency signals with speech removed.

Thus, the arrangement of FIG. 5 may provide the speech steering vectors, speech time-frequency signal and microphone signals with speech removed as its output, which are also the outputs of speech separator 402 of FIG. 4.

Diagram 600 of FIG. 6 illustrates operation of an example implementation of object direction determiner 403 of FIG. 4. Functionalities (including, e.g., speech multi-microphone signal generator 601, metadata determiner 602, vectorization and averaging 603, and/or vector-to-DOA conversion 604) of diagram 600 may, for example, be carried out by at least one processor 202 and at least one memory 204.

As shown in FIG. 6, the speech steering vector V(n, b, i) and the speech time-frequency signal S_{speech}(n, b) may be provided to speech multi-microphone signal generator 601, which may generate a multi-microphone speech response:

$${S}_{speech , mics} ( n , b , i ) = V ( n , b , i ) {S}_{speech} ( n , b )$$

which is the speech multi-microphone time-frequency signal, provided from speech multi-microphone signal generator 601 to metadata determiner 602. Alternatively, the speech time-frequency signal and steering vector may be together as a multi-channel speech time-frequency signal, in which case speech multi-microphone signal generator 601 may be bypassed.

Metadata determiner 602 of FIG. 6 may operate under the same principles as metadata determiner 405 of FIG. 4. It may determine the direction and the direct-to-total energy ratio parameter in frequency bands. As described previously, the operation details of metadata determiner 602 may depend on the microphone 206A, 206B array configuration, and two example configurations are detailed in the following.

As the first example, the microphone array signals may be first-order Ambisonics (FOA) signals (or have been converted to FOA signals from other arrangements). FOA signals comprise four channels, where the first channel is an omnidirectional (i.e., zeroth order) W signal, and the three remaining channels are the Y, Z, and X axes figure-of-eight pattern (i.e., first-order) signals. Here, it is assumed that the speech multi-microphone time-frequency signal S_{speech,mics}(n, b, i) corresponds to this channel order as well. Metadata determiner 602 may formulate first the XYZ-order intensity vector, e.g., by:

$$I ( n , k ) = {\sum }_{b = {b}_{low} ( k )}^{{b}_{high} ( k )} Real ( {S}_{speech , mics}^{*} ( n , b , 1 ) [ \begin{matrix}{S}_{speech , mics} ( n , b , 4 ) \\ {S}_{speech , mics} ( n , b , 2 ) \\ {S}_{speech , mics} ( n , b , 3 )\end{matrix} ] )$$

where superscript * denotes a complex conjugate, and Real( ) operator takes the real part of its complex-valued input. Index k is a frequency band index that comprises one or more frequency bins b, ranging from b_{low}(k) to b_{high}(k).

It is to be noted that above a frequency band index f was also used, also comprising one or more frequency bins b for each f. In some embodiments, the frequency bands k and f may correspond to the same frequency resolution, but in the present example they are different. The frequency resolution k relates to the spatial metadata determination, and the frequency resolution f is the one where the speech-mask generating machine learning model operates, and the optimal frequency resolution of these two is typically different.

Next, an overall energy may be formulated by:

$$E ( n , k ) = 0.5 {\sum }_{b = {b}_{low} ( k )}^{{b}_{high} ( k )} {\sum }_{i = 1}^{4} {\vert {S}_{speech , mics} ( n , b , i ) \vert}^{2}$$

In some examples, the values I(n, k) and E(n, k) may further be averaged over time, for example, using an infinite impulse response (IIR) averaging scheme.

Then, the direction and ratio values may be determined so that DOA_{speech}(k, n) is the direction of vector I(n, k), and the direct-to-total ratio parameter may be formulated by:

$${r}_{speech} ( n , k ) = \frac{\vert I ( n , k ) \vert}{E ( n , k )}$$

The DOA_{speech}(k, n) and r_{speech}(n, k) are then the DOA and ratio output by metadata determiner 602. For example, the r_{speech}(k, n) of the determined speech signal may be 1 or close to 1, as it is an estimate of an actual directional sound and not ambience.

In another configuration, the microphone 206A, 206B arrangement may be mounted on user device 200 that is a mobile phone. As an example, user device 200 in question may be a smartphone in a landscape orientation, with microphones at the left and right edges, and a third microphone near a main camera. For such devices, a method to analyse the DOA_{speech}(k, n) and r_{speech}(n, k) may be performed with delay analysis between the microphone pairs, as described in the following.

First, channel indices i=1,2 of S_{speech,mics}(n, b, i) may be assumed to be the two channels that correspond to the left and right edges, and i=3 may be the microphone near the main camera. Then, a set of delays may be defined, for example, 41 delay values d ranging uniformly from d=−20 samples to d=20 samples. Assuming a sampling rate of 48 kHz, this maximum of 20 samples delay may correspond to an acoustic propagation in a free field for a 14.3 cm distance. As such, this delay search range may be suitable for devices that are approximately 14 cm wide or smaller. For larger devices, a larger search range may be defined. Then, metadata determiner 602 may formulate the delayed cross correlation, e.g., by:

$${c}_{{i}_{1} , {i}_{2}} ( n , b , d ) = {S}_{speech , mics} ( n , b , {i}_{1} ) {S}_{speech , mics}^{*} ( n , b , {i}_{2} ) {e}^{i 2 π f ( b ) t ( d )}$$

where f(b) is the center frequency of bin b in Hz and t(d)=d/48000 is the sample delay value d converted to seconds. Then, a normalized cross-correlation may be formulated in frequency bands, e.g., by:

$${c}_{1 , 2 , norm} ( n , k , d ) = \frac{Real ( {\sum }_{b = {b}_{low} ( k )}^{{b}_{high} ( k )} {c}_{1 , 2} ( n , b , d ) )}{\sqrt{( {\sum }_{b = {b}_{low} ( k )}^{{b}_{high} ( k )} {c}_{1 , 1} ( n , b , 0 ) ) ( {\sum }_{b = {b}_{low} ( k )}^{{b}_{high} ( k )} {c}_{2 , 2} ( n , b , 0 ) )}}$$

Next, from the search range of d=−20 . . . 20, the largest c_{1,2,norm}(n, k, d) may be identified. The delay value that corresponds to the maximum c_{1,2,norm}(n, k, d) may be denoted dₘₐₓ(n, k). The delay value may be converted to an azimuth value, e.g., by:

$$azi ( n , k ) = {sin}^{- 1} ( {trunc}_{- 1 , 1} ( \frac{{d}_{max} ( n , k )}{{d}_{device}} ) )$$

where d_{device} is the maximum delay in samples obtainable by the left-right microphone pair for a sound arriving directly from the side, and trunc_{a,b} is an operation truncating values to a range between a and b. For example, for user device 200 that is 14.3 cm wide d_{device}=20.

The above formulation may provide an azimuth estimate between −90 and 90 degrees. However, the analysis was performed only on the left-right microphone pair, and therefore this analysis may cause any direction estimates from the rear side to have been mirrored to the front. Next, the front-back analysis may be performed by using a correlation analysis between the camera microphone and the nearest side microphone. This analysis may be the same as above, but using a finer resolution for the delay value and a shorter search interval. In this analysis step, it may only be determined, for each time-frequency region (n, k), if the highest correlation is observed for positive or negative values of d, which may then provide the information if the sound is more front or more back. If it is determined that the sound is at the back, then the azimuth angle may be mirrored to the rear, for example, an 80-degree azimuth value may be mirrored to 100 degrees; or 0 degrees azimuth may be mirrored to 180 degrees, and correspondingly for other azimuth angles.

Next, the direct-to-total ratio may be estimated, e.g., by:

$${r}_{speech} ( k , n ) = {trunc}_{0 , 1} ( \frac{{c}_{1 , 2 , norm} ( n , k , {d}_{max} ( n , k ) ) - {c}_{diff} ( k )}{1 - {c}_{diff} ( k )} )$$

where c_{diff}(k) is the diffuse field normalized cross-correlation of the left-right microphone pair the device in question.

The DOA_{speech}(k, n) of the DOA and ratio is then the estimated azi(n, k) (with the applied front-back mirroring), and the ratio is the r_{speech}(k, n) is as described above. If user device 200 has only two microphones (at the left and right edges), then the front-back mirroring processing may be omitted.

In the above, two separate methods for metadata determiner 602 were detailed for two separate types of microphone arrays. Metadata determiner 602 may also operate under different principles, as long as the DOA and ratio DOA_{speech}(k, n) and r_{speech}(k, n) may be estimated. The DOA and ratio may be provided to vectorization and averaging block 603.

Vectorization and averaging block 603 may first determine a vector form of the DOA and ratio. This may be done by generating a vector that points towards DOA_{speech}c(k, n) and has the length r_{speech}(k, n). This vector is denoted vₛₜₑₑᵣ(k, n).

Then, an energy-weighted sum vector may be formulated across frequency, e.g., by:

$${{v}^{′}}_{steer} ( n ) = {\sum }_{k} {E}_{speech} ( k , n ) {v}_{steer} ( k , n ) .$$

In some examples, the above equation may further have different weighting in different frequency bands k. For example, the ratio of speech energy at band k with respect to original signal energy may be used as a weighting factor. Alternatively, or additionally, perceptual A-weighting may be used. The E_{speech}(k, n) is the estimated energy of the speech time-frequency signal at band k and temporal step n, obtained, e.g., by:

$${E}_{speech} ( k , n ) = {\sum }_{b = {b}_{low} ( k )}^{{b}_{high} ( k )} {\vert {S}_{speech} ( n , b ) \vert}^{2}$$

After this, the weighted sum vector may be temporally averaged, e.g., by:

$${{v}^{″}}_{steer} ( n ) = {α}_{obj} {{v}^{″}}_{steer} ( n - 1 ) + ( 1 - {α}_{obj} ) {{v}^{′}}_{steer} ( n )$$

where α_{obj} is a value determining temporal averaging and v″ₛₜₑₑᵣ(0) may be assumed to be a vector of zeros. In some configurations, the α_{obj} may be set high, for example 0.95, if high spatial stability of the object direction is desired. This may be a case when it is known that there is only one talker in the scene. If there are multiple talkers, or if the talker direction may change rapidly, smaller values, or even zero value may be used for α_{obj}. In some configurations, the value α_{obj} may be adapted over time based on scene analysis.

The v″ₛₜₑₑᵣ(n) is the speech direction vector output by vectorization and averaging block 603.

Vector-to-DOA conversion 604 may then obtain the speech direction vector and convert it to the object direction. For example, if the object direction is determined as an azimuth-elevation pair, then the conversion may be performed, e.g., by:

$${azi}_{obj} ( n ) = a tan 2 ( {{v}^{″}}_{steer} ( n , 2 ) , {{v}^{″}}_{steer} ( n , 1 ) )$$

$${ele}_{obj} ( n ) = a tan 2 ( {{v}^{″}}_{steer} ( n , 3 ) , \sqrt{{( {{v}^{″}}_{steer} ( n , 1 ) )}^{2} + {( {{v}^{″}}_{steer} ( n , 2 ) )}^{2}} )$$

where v″ₛₜₑₑᵣ(n)=[v″ₛₜₑₑᵣ(n, 1) v″ₛₜₑₑᵣ(n, 2) v″ₛₜₑₑᵣ(n, 3)]^{T} is assumed to be in XYZ order. The azi_{obj}(n) and ele_{obj}(n) may then form the object direction output by object direction determiner 403.

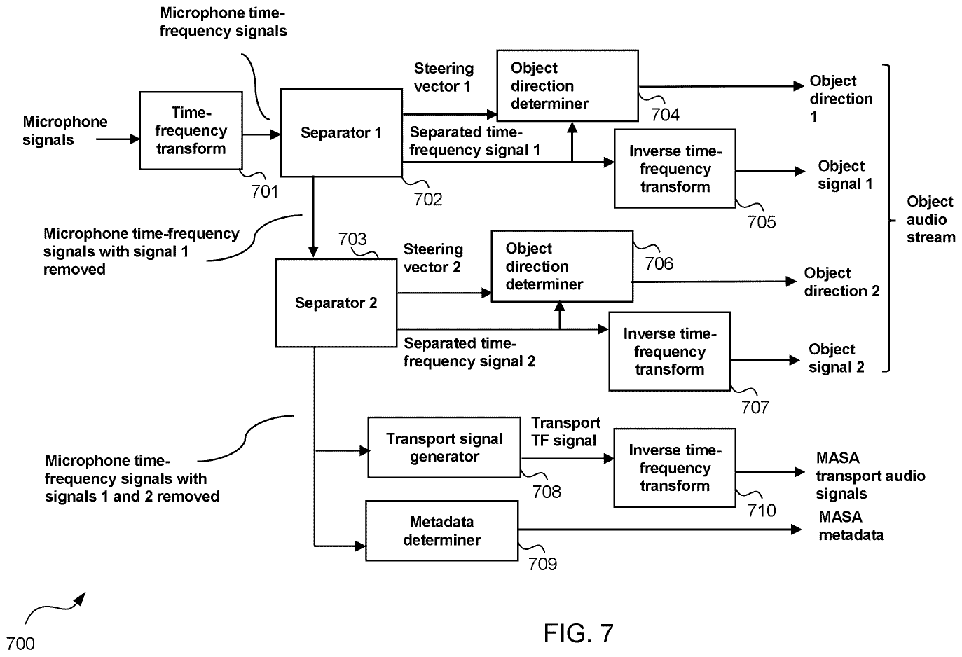

Diagram 700 of FIG. 7 illustrates operation of another example implementation of front-end 301 of FIG. 3. Functionalities (including, e.g., time-frequency transform 701, separator 1 702, separator 2 703, object direction determiner 704, inverse time-frequency transform 705, object direction determiner 706, inverse time-frequency transform 707, transport signal generator 708, metadata determiner 709, and/or inverse time-frequency transform 710) of diagram 700 may, for example, be carried out by at least one processor 202 and at least one memory 204.

Above, one speech signal was separated as an audio object. More generally, the same processing may be done for other types of signals than speech. The only change needed is that the machine learning model within the speech separator is trained to estimate the spectral mask for the other signal type, and otherwise the processing may be as above.

Furthermore, more than one object may be separated, as shown in an alternative front-end of FIG. 7, with two objects. With a similar structure, there may be more than two objects, by having more separators.

The processing blocks of FIG. 7 may operate the same way as in FIG. 4. Here, the separators are denoted generally as separator 1 702 and separator 2 703. They may be speech separators, so that separator 1 702 identifies a first talker, and the separator 2 703 identifies a second talker. Alternatively, one of the separators may be a speech separator, and the other may be a separator for some other sound type. Apart from differently trained machine learning models to estimate the mask gains within the separators, all other operators, such as beamformers, object direction determiners and so forth, may then operate as described above.

As shown in FIG. 7, in the alternative front-end, one object may first be separated from the microphone time-frequency signals, and object direction 1 and object signal 1 may be obtained. Also, microphone signals with signal 1 removed may be obtained. Then, from this signal with first object removed, the object separation process may be repeated so that object direction 2 and object signal 2 may be obtained. Also, the remainder microphone signals with signals 1 and 2 removed may be formulated, from which MASA transport audio signals and MASA metadata may be formulated, using means described above.

In the same way, there may be more steps to remove more than two objects.

In the following, examples of functionalities of user device 200 implemented as encoder 302 are described in more detail using speech as an example of audio content.

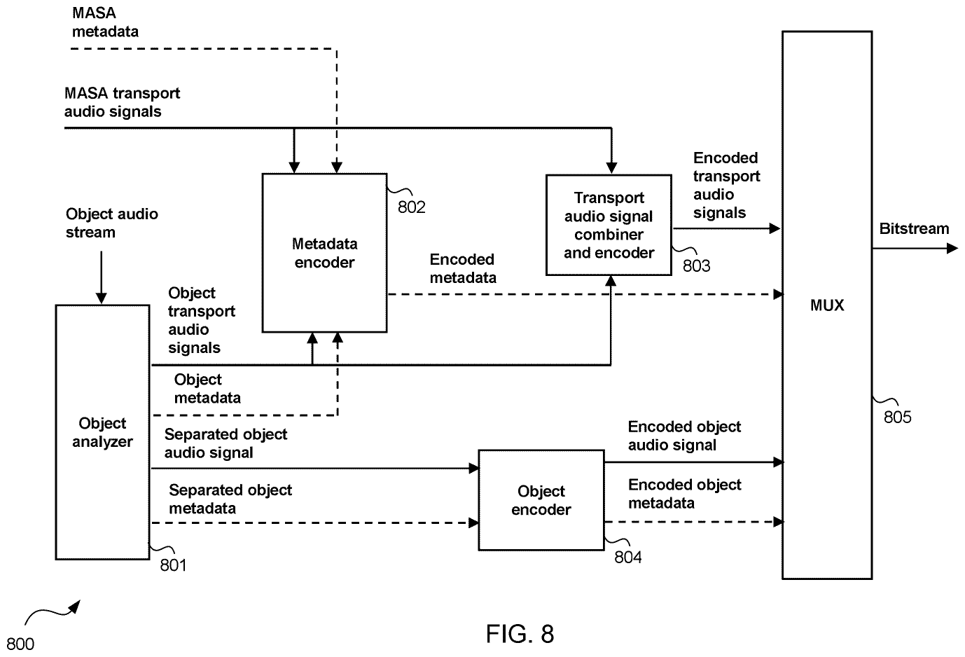

Diagram 800 of FIG. 8 illustrates operation of an example implementation of encoder 302 of FIG. 3. Functionalities (including, e.g., object analyzer 801, metadata encoder 802, transport audio signal combiner and encoder 803, object encoder 804, and/or multiplexer 805) of diagram 800 may, for example, be carried out by at least one processor 202 and at least one memory 204.

The input to encoder 302 may comprise a MASA stream (comprising MASA transport audio signals and MASA metadata) and an object audio stream (comprising N objects). The objects may comprise an audio signal and associated object metadata (e.g., the direction of the object, e.g., as an azimuth and an elevation) for each object.

The disclosed example embodiment may follow the IVAS encoding of the OMASA input at mid bitrates (e.g., when having 3-4 objects and a MASA stream at the bit rate of 64 kbps). However, the disclosure may be applied also at other bitrates and different number of objects (an alternative example encoder 302 is disclosed further below). Furthermore, the disclosure may also be applied in other encoders that utilize parametric spatial audio and audio objects as an input.

The object audio stream may be fed to object analyzer block 801, which may analyse the object audio stream to determine which object to separate from the other objects. The result of this is separated object audio signal and separated object metadata which may be output from block 801. The separated object metadata may comprise, e.g., the object direction and the index of the object that was separated.

Next, the remaining objects may be analyzed at object analyzer 801 to determine object transport audio signals and object metadata. The metadata may may comprise any suitable metadata. As an example, the object audio signals may be downmixed to a stereo downmix using amplitude panning based on the object directions, and the object metadata may comprise the object directions and time-frequency domain object-to-total energy ratios (or ISM ratios in other words), which may be obtained by analyzing the energies of the different objects in frequency bands and comparing them to the total energy of all objects in the corresponding bands.

The separated object audio signal and separated object metadata may be forwarded to object encoder 804, which may encode them using suitable methods. The resulting encoded object audio signal and encoded object metadata may be output from block 804.

The MASA transport audio signals and object transport audio signals may be forwarded to transport audio signal combiner and encoder block 803. The transport audio signals may be combined, e.g., by summing them. Transport audio signal combiner and encoder block 803 may also encode the combined transport audio signals, e.g., using an IVAS core codec or any other suitable codec.

The MASA metadata, object metadata, MASA transport audio signals, and the object transport audio signals may be forwarded to metadata encoder 802. Metadata encoder 802 may apply suitable encoding to the metadata.

First, MASA-to-total energy ratios may be determined using the MASA transport audio signals and the object transport audio signals, e.g., by computing the energies of the MASA and the object transport audio signals in time-frequency tiles, and then determining the MASA-to-total energy ratios, e.g., by:

$$μ ( k , n ) = \frac{{E}_{MASA} ( k , n )}{{E}_{MASA} ( k , n ) + {E}_{obj} ( k , n )}$$

where E_{MASA}(k, n) is the energy of the MASA transport audio signals for the frequency band k and temporal subframe n, and E_{obj} (k, n) the energy of the object transport audio signals.

Then, the MASA metadata, the object directions, the ISM ratios, and the MASA-to-total energy ratios may be encoded using any suitable methods. The resulting encoded metadata may be output from block 802.

The encoding of the MASA stream and the object audio stream may have adaptive distribution of the bitrate. I.e., the total IVAS bitrate (e.g., that 64 kbps) may be adaptively distributed for the encoded transport audio signals, encoded metadata, encoded object audio signal, and encoded object metadata based on the analysis of the audio signals. In practice, more bit budget may be given for the audio signals that are perceptually more important. E.g., if the separated object audio signal is inactive, majority of the bit budget may be given for the encoded transport audio signal, and vice versa. As a result, optimized audio quality may be obtained, as the most perceptually important audio signal gets the most bit budget.

The encoded transport audio signals, encoded metadata, encoded object audio signal, and encoded object metadata may be forwarded to multiplexer 805, which may multiplex them to a bitstream, which is the output of encoder 302.

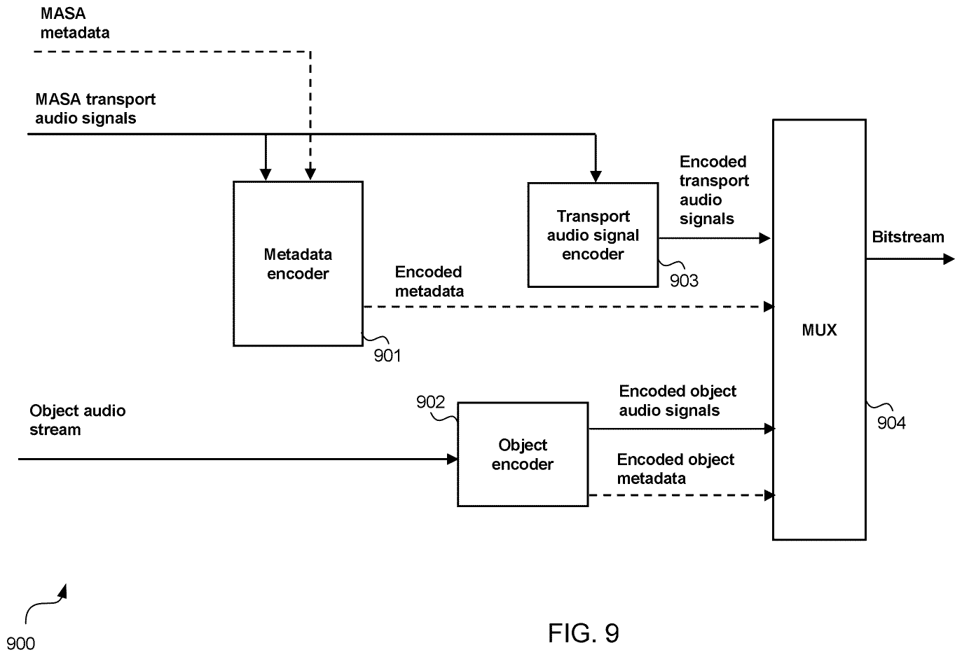

Diagram 900 of FIG. 9 illustrates operation of another example implementation of encoder 302 of FIG. 3. Functionalities (including, e.g., metadata encoder 901, object encoder 902, and/or transport audio signal encoder 903) of diagram 900 may, for example, be carried out by at least one processor 202 and at least one memory 204.

FIG. 9 presents an alternative example encoder that may encode all objects separately. The input to the encoder of FIG. 9 may comprise a MASA stream (comprising MASA transport audio signals and MASA metadata) and an object audio stream (comprising N objects). The objects may comprise an audio signal and associated object metadata (e.g., the direction of the object, e.g., as an azimuth and an elevation) for each object.

The disclosed example embodiment follows the IVAS encoding of the OMASA input at higher bitrates (e.g., when having 3-4 objects and a MASA stream at the bit rate of 128 kbps, or 1-2 objects and a MASA stream at the bit rate of 64 kbps).

In this embodiment, the object audio stream may be directly forwarded to object encoder 902. Object encoder 902 may encode the object audio signal of each object separately, and it may also encode the object metadata for each object. As a result, encoded object audio signals and encoded object metadata for each object may be obtained.

The rest may operate as was presented above in relation to the embodiment of FIG. 8, with the difference that metadata encoder 901 may encode only the MASA metadata, and transport audio signal encoder 903 may not perform combination of the audio signals, and may only encode the MASA transport audio signals. As a result, encoded transport audio signals and encoded metadata may be obtained.

Similarly, as for the previous embodiment, the bitrate adaptation may be performed also in this embodiment. However, in this embodiment, there are multiple object audio signals, so the bit budget may be adaptively divided also among them (and the MASA audio signals).

The encoded transport audio signals, encoded metadata, encoded object audio signal, and encoded object metadata may be forwarded to multiplexer 904, which may multiplex them to a bitstream, which is the output of the encoder of FIG. 9.

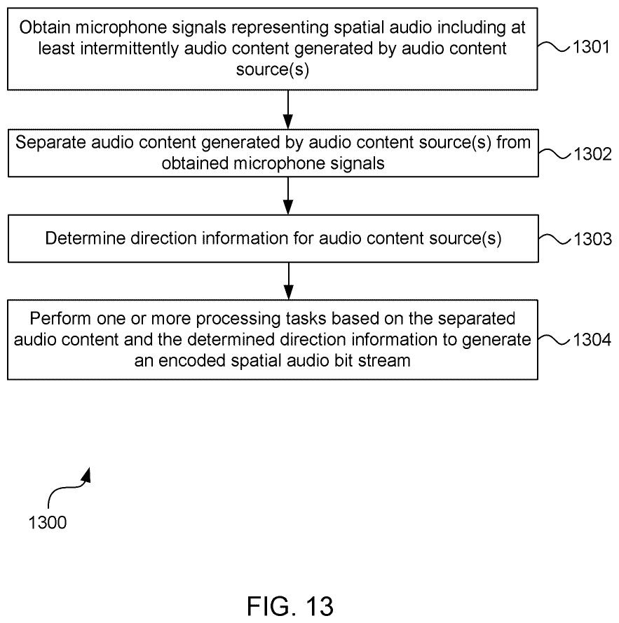

FIG. 13 illustrates an example flow chart of method 1300 for user device 200, in accordance with an example embodiment.

At operation 1301, user device 200 obtains the at least two microphone signals that represent the spatial audio that includes at least intermittently the audio content generated by at least one audio content source 111, 112. The at least two microphone signals have been captured with at least two microphones 206A, 206B.

At operation 1302, user device 200 separates, at least partly, the audio content generated by at least one audio content source 111, 112 from the obtained at least two microphone signals.

At operation 1303, user device 200 determines the direction information for at least one audio content source 111, 112. As described above in more detail, the direction information comprises the information about the spatial direction which the audio content generated by at least one audio content source 111, 112 originates from with respect to at least two microphones 206A, 206B.

At operation 1304, user device 200 performs the one or more processing tasks based on the separated audio content and the determined direction information, in order to generate the encoded spatial audio bit stream.

Embodiments and examples with regard to FIG. 13 may be carried out by user device 200 of FIG. 2A. Operations 1301-1304 may, for example, be carried out by at least one processor 202 and at least one memory 204. Further features of method 1300 directly resulting from the functionalities and parameters of user device 200 are not repeated here. Method 1300 can be carried out by computer program(s) or portions thereof.

Another example of an apparatus suitable for carrying out the embodiments and examples with regard to FIG. 13 comprises means for:
obtaining, at operation 1301, at least two microphone signals representing spatial audio including at least intermittently audio content generated by at least one audio content source, the at least two microphone signals captured with at least two microphones;
separating, at operation 1302, at least partly the audio content generated by the at least one audio content source from the obtained at least two microphone signals;
determining, at operation 1303, direction information for the at least one audio content source, the direction information comprising information about a spatial direction which the audio content generated by the at least one audio content source originates from with respect to the at least two microphones; and
performing, at operation 1304, one or more processing tasks based on the separated audio content and the determined direction information to generate an encoded spatial audio bit stream.

FIG. 2B is a block diagram of user device 210, in accordance with an example embodiment.

User device 210 comprises one or more processors 212 and one or more memories 214 that comprise computer program code. User device 210 may also comprise or be connected to headphones 216.

User device 210 may also include (or be connected to) other elements, such as transceiver 218 configured to enable user device 210 to transmit and/or receive information to/from other devices, as well as other elements not shown in FIG. 2B (e.g., at least two internal microphones, such as a microphone array or the like). Alternatively/additionally, at least some of microphones may be external to user device 210 and connected to user device 210 via wireless or wired connection. In one example, user device 210 may use transceiver 218 to transmit or receive signalling information and data in accordance with at least one cellular communication protocol. Transceiver 218 may be configured to provide at least one wireless radio connection, such as for example a 3GPP mobile broadband connection (e.g., 5G or 6G). Transceiver 218 may comprise, or be configured to be coupled to, at least one antenna to transmit and/or receive radio frequency signals.

Although user device 210 is depicted to include only one processor 212, user device 210 may include more processors. In an embodiment, memory 214 is capable of storing instructions, such as an operating system and/or various applications. Furthermore, memory 214 may include a storage that may be used to store, e.g., at least some of the information and data used in the disclosed embodiments.

Furthermore, processor 212 is capable of executing the stored instructions. In an embodiment, processor 212 may be embodied as a multi-core processor, a single core processor, or a combination of one or more multi-core processors and one or more single core processors. For example, processor 212 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network (NN) chip, an artificial intelligence (AI) accelerator, a tensor processing unit (TPU), a neural processing unit (NPU), or the like. In an embodiment, processor 212 may be configured to execute hard-coded functionality. In an embodiment, processor 212 is embodied as an executor of software instructions, wherein the instructions may specifically configure processor 212 to perform the algorithms and/or operations described herein when the instructions are executed.

Memory 214 may be embodied as one or more volatile memory devices, one or more non-volatile memory devices, and/or a combination of one or more volatile memory devices and non-volatile memory devices. For example, memory 214 may be embodied as semiconductor memories (such as mask ROM, PROM (programmable ROM), EPROM (erasable PROM), flash ROM, RAM (random access memory), etc.

In the following, examples of above-described functionalities of user device 210 implemented as decoder 303 are described in more detail using speech as an example of audio content.

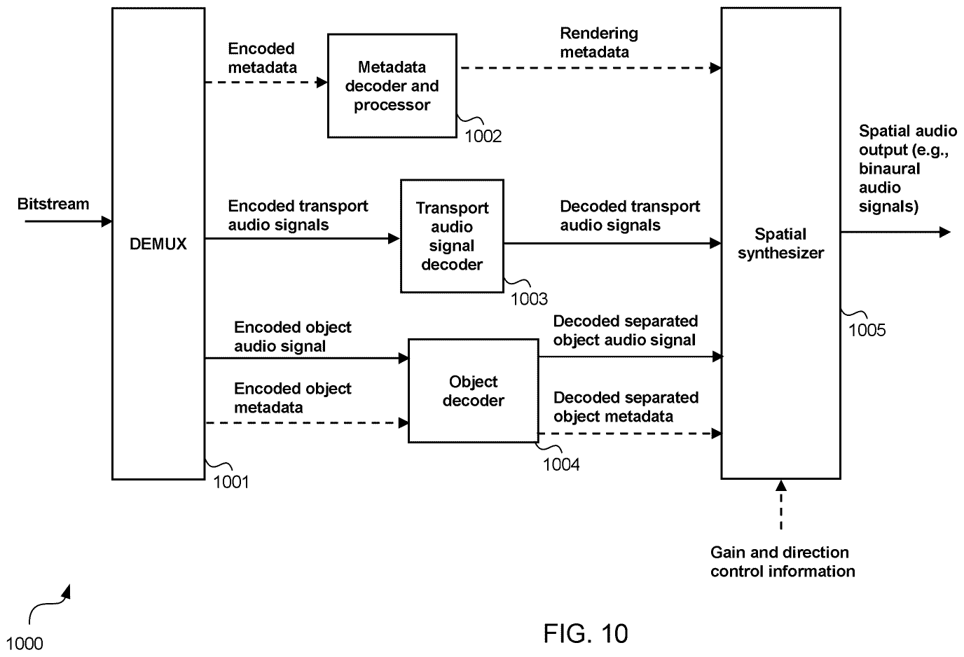

Diagram 1000 of FIG. 10 illustrates operation of an example implementation of decoder 303 of FIG. 3. Functionalities (including, e.g., demultiplexer 1001, metadata decoder and processor 1002, transport audio signal decoder 1003, object decoder 1004, and/or spatial synthesizer 1005) of diagram 1000 may, for example, be carried out by at least one processor 212 and at least one memory 214. Decoder 303 may be used together with encoder 302. The input to decoder 303 is the bitstream. The bitstream may be fed to demultiplexer block 1001, which may demultiplex it to encoded transport audio signals, encoded metadata, encoded object audio signal, and encoded object metadata.

The encoded transport audio signals may be fed to transport audio signal decoder 1003, which may decode them to decoded transport audio signals.

The encoded metadata may be fed to metadata decoder and processor 1002, which may decode the metadata, and process it to a suitable form for rendering. The decoding may be performed using methods corresponding to the encoding methods applied in metadata encoder block 802 or 901. As a result, decoded MASA metadata, MASA-to-total energy ratios, ISM ratios, and object directions may be obtained.

These metadata may be converted to a form that is more suitable for rendering. First, the direct-to-total energy ratios in the MASA metadata may be modified by multiplying them with the MASA-to-total energy ratio:

$${r}_{MASA , rend} ( k , n ) = μ ( k , n ) {r}_{MASA} ( k , n ) .$$

The rest of the MASA metadata (directions DOA_{MASA}(k, n), spread coherences f_{MASA}(k, n), and surround coherences γ_{MASA}(k, n)) may be used without modifications.

The ISM ratios r_{ISM}(k, n, o) may be modified, e.g., by:

$${r}_{ISM , rend} ( k , n , o ) = ( 1 - μ ( k , n ) ) {r}_{ISM} ( k , n , o )$$

where o is the object index. The object directions may be used without modifications (directions DOA_{ISM}(n, o)).

The resulting rendering metadata (DOA_{MASA}(k, n), r_{MASA,rend}(k, n) ξ_{MASA}(k, n), γ_{MASA}(k, n), DOA_{ISM}(n, o), r_{ISM,rend}(k, n, o)) may then be provided as output of metadata decoder and processor 1002.

The encoded object audio signal and encoded object metadata may be forwarded to object decoder 1004, which may decode them to decoded separated object audio signal and decoded separated object metadata, comprising the direction DOAₛₑₚ(n) and the object index oₛₑₚ(n).

Spatial synthesizer 1005 may obtain rendering metadata, decoded transport audio signals, decoded object audio signal, and decoded object metadata. Moreover, spatial synthesizer 1005 may obtain gain and direction control information, in case the direction and/or gain of one or more objects is edited in the decoder (or the gain of the MASA part). Spatial synthesizer 1005 may synthesize spatial audio output as an output, e.g., binaural audio signals.

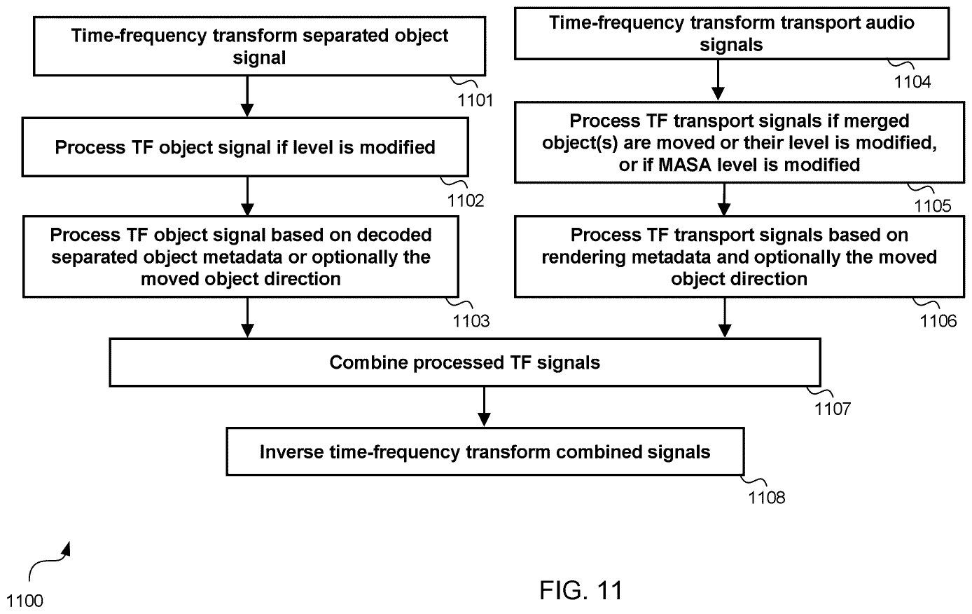

Diagram 1100 of FIG. 11 illustrates operation of an example implementation of spatial synthesizer 1005 of FIG. 10. Functionalities (including, e.g., steps 1101-1108) of diagram 1100 may, for example, be carried out by at least one processor 212 and at least one memory 214.

First operation is to apply time-frequency transform to both decoded separated object audio signal (operation 1101) and decoded transport audio signals (operation 1104) using a complex low-delay filter bank (CLDFB), to obtain time-frequency (TF) object signal and time-frequency transport signals.

Next, the time-frequency object signal level may be processed at operation 1102 if the gain and direction control information indicates level modification.

Also, the time-frequency transport signals may be processed if the gain and direction control information indicates level or direction modification of at least one of the objects within the transport audio signals or level modification of the MASA part, operation 1105. For example, if some object audio signal resides in the left channel of the transport signals, but it is re-positioned towards right, then this processing step may re-mix the transport signal channels to move the object signal (at least partially) to the right channel.

Then, the time-frequency object signal may be processed based on the decoded separated object metadata, or the direction in the gain and direction control information, if this object has been moved, operation 1103. This step may include determining a head-related transfer function (HRTF) pair based on the object direction, and processing the time-frequency object signal based on it.

Also, the time-frequency transport signals may be processed based on the rendering metadata (and optionally the gain and direction control information, if one or more objects within the transport audio signals have been moved), operation 1106. This operation may use a covariance matrix-based approach, where a target covariance matrix may be determined based on the rendering metadata (and optionally the gain and direction control information) so that it has the binaural features according to the metadata. Then, based on the target covariance matrix and the measured transport signal covariance matrix, processing matrices may be determined and applied to the time-frequency transport signals. The processing may also include usage of decorrelation when necessary.

Then, the processed parts of the above steps may be combined, by adding them together, operation 1107. The processing and combining may also be implemented as a unified processing step so that there is a 3-to-2 channel processing matrix that processes the two transport channels and the separated object channel as a 3-channel input.

Finally, the combined time-frequency signal is inverse transformed, with an inverse CLDFB, to obtain spatial audio output that is a binaural output signal, operation 1108.

In some examples, spatial synthesizer 1005 may receive all objects separately, i.e., the MASA signal does not have any merged objects. In that case, spatial synthesizer 1005 may work otherwise as described above, but so that any object movement or object-related metadata do not affect the rendering of the MASA part.

An alternative example embodiment of a decoder may operate similarly as the decoder presented in FIG. 10, but here may be multiple separately encoded objects. Thus, they may all be decoded and separately rendered. Moreover, a metadata decoder may decode only the MASA metadata, and no metadata modification is needed, as the decoded MASA metadata may be directly suitable to be used for rendering. Otherwise, the blocks of such an alternative decoder may operate as described above.

In the above example embodiments, only the direction and direct-to-total energy ratio parameters of the MASA stream were discussed. In alternative embodiments, also other MASA parameters may be determined. E.g., the spread and surround coherence parameter values may be obtained from, e.g., Ambisonic input.

In some alternative embodiments, the object direction of front-end 301 may be obtained via other means than the analysis of the microphone signals. For example, a talker may be wearing a device (e.g., headphones) the position of which may be tracked to obtain the object direction.

In some alternative embodiments, the object signal of front-end 301 may be obtained via other means than separation from the microphone signals. For example, a user may be wearing a device with microphone(s), such as headphones, from which the speech that is the object signal is obtained.

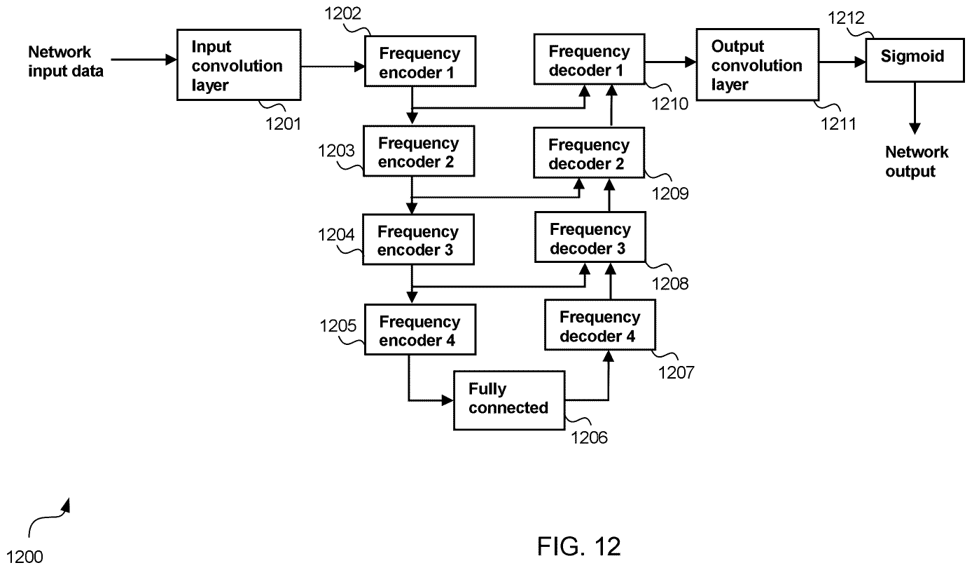

Diagram 1200 of FIG. 12 illustrates an example network structure for use in machine learning training.

In the following, details to define, train and perform inference with ML models is described.

An offline pre-processing part may comprise training a machine learning network for speech mask estimation.

Herein, when using the term ‘channel’, it refers to audio channels of a multi-channel signal. However, in machine learning literature, a channel is an often-used term that refers to a particular axis of the data flowing through the network, for example, a convolution layer having 32 filters produces 32 channels. To distinguish the meanings, here channel is used for audio, and feature is used when discussing the particular dimension of the data in the machine learning model.

The above trained network refers to a machine learning model or network that has been trained based on a large set of input data examples to predict a corresponding set of output data examples. In the following, the example input data, output data, network architecture and training procedure is described. As is typical in the field of machine learning, there is no single type of network structure that must be used to achieve a certain goal, but instead there are many ways to alter the network structure (e.g., different network type, different number of filters, different number of layers, etc.).

In the disclosed example, a structure is defined that aims for computational simplicity. More complex structures may be implemented to enable a higher accuracy in the prediction task.

FIG. 12 shows an example network structure 1200 that is used in the disclosed examples. It is configured to receive network input data as an input, which is of form (num_T×num_F×num_C), where num_T is the number of temporal indices and num_F is the number of frequency bands and num_C is the number of input features. For frequency axis, num_F=96 may be set, and for input features num_C=1, since there is only one input feature which is a spectrogram. For time axis, num_T=64 may be used. Note that this time axis is the size of the network training input sample, not the time dimension of the network.

The network input in training is thus of shape (64×96×1). The network input data is denoted as I(n, f) where n is the temporal index, f is the frequency band index of the network input, and the unity dimension of the features is omitted in this notation.

The first feature of the network input (in training) may be obtained by first obtaining the energy value E_{dB}(n, f) in decibels in frequency bands, e.g., as:

$${E}_{dB} ( n , f ) = 10 {log}_{10} {\sum }_{b = {b}_{low} ( f )}^{{b}_{high} ( f )} {\sum }_{i = 1}^{{N}_{ch}} {\vert S ( b , n , i ) \vert}^{2}$$

where b_{low}(f) and b_{high}(f) are the indices for the lowest and highest frequency bins of frequency band f. S(b, n, i) here refers to the training input audio data processed with STFT. In the training time, there is only one channel i, but in the inference time there may be one or more channels i.

Then, a limiter value E_{dB_max}(f) may be formulated that is the largest of E_{dB}(n, f) over the whole data range n=1, . . . , 64, for each f independently, and the data may be lower-limited, e.g., by:

$${{E}^{′}}_{dB} ( n , f ) = max ( {E}_{dB} ( n , f ) , {E}_{dB \_ max} ( f ) - 60 ) .$$

Then, the data may be normalized and set to as the network input data:

$$I ( n , f ) = \frac{{{E}^{′}}_{dB} ( n , f ) - {{E}^{′}}_{dB \_ mean} ( f )}{{{E}^{′}}_{dB \_ std} ( f )}$$

where the E′_{dB,mean}(f) is the mean and E′_{dB_std}(f) is the standard deviation of E′_{dB}(n, f) over the complete data range n=1, . . . , 64, for each band independently.

The network structure of FIG. 12 is described next. The first layer in the network to process the network input I(n, f) is input convolution layer 1201 that may comprise 20 filters of size 1×20 without zero padding. In machine learning terminology, this means that padding is set valid. This means that the convolution maps the 20 temporal indices of the data to 20 feature indices. In other words, the output of this layer is (45×96×20) in the training phase. The resulting data may be provided to frequency encoder 1 block 1202.

The temporal axis was reduced from 64 to 45 due to this operation, so at the training the network receives 64 temporal indices data but provides estimates only for 45 outputs. This corresponds to the inference stage situation where the network is provided with 20 temporal indices data, and provides only one temporal index of data, the current temporal frame gains.

Each of the frequency encoder blocks may comprise a sequence of the following layers: 1) batch normalization, 2) rectified linear unit (ReLU) and 3) convolution. The filters may be of shape (1×3) and have stride (1,2), and they may thus operate only on the frequency dimension (i.e., not temporal). In other words, having a filter of size (1×3) means convolution only on frequency dimension and having a stride of (1,2) means downsampling by factor of 2 only on the frequency dimension, while the temporal dimension is not downsampled. The frequency encoders may operate on the following number of output features: frequency encoder 1 (1202): 32; frequency encoder 2 (1203): 64; frequency encoder 3 (1204): 64; frequency encoder 4 (1205): 128. Each frequency encoder block (except for the last one) may provide its output to the next encoder, but also to a corresponding-level frequency decoder block 1207-1210. The last frequency encoder 4 block 1205 may provide its output to fully connected block 1206. At this stage, the data is at form (45×6×128), so the frequency dimension has been gradually reduced to 6.

Fully connected block 1206 may reshape the last two dimensions of (45×6×128) to shape (45×768), and apply 1) batch normalisation, 2) ReLu, and 3) dense (i.e., fully connected) operation to the data. The resulting data is reshaped from (45×768) back to shape (45×6×128), and provided to the frequency decoder 4 (1207).

Similarly to frequency encoders 1202-1205, frequency decoders 1207-1210 may operate only on the frequency axis. Except for the frequency decoder 4 (1207), which obtains the input only from fully connected block 1206, the other frequency decoders 1208-1210 may obtain two inputs, first being the output of the corresponding index frequency encoder and second being the output of the previous frequency decoder. These frequency decoders 1208-1210 may concatenate the two input data sets on the feature axis for processing. For example, when frequency decoder 3 (1208) receives data from frequency encoder 3 (1204) in from (45×12×64) and from frequency decoder 4 (1207) data in form (45×12×128), the concatenated data is of form (45×12×192). These frequency decoders may include the following layers: 1) batch normalization, 2) rectified linear unit (ReLU) and 3) transposed convolution. The filters may be of shape (1×3) and have stride (1,2). The frequency decoder may operate on the following number of output features: frequency decoder 1 (1210): 32; frequency decoder 2 (1209): 64; frequency decoder 3 (1208): 64: frequency decoder 4 (1207): 128. The output of the frequency decoder 1 (1210) may then be of shape (45×96×32).

Frequency decoder 1 (1210) may finally provide its output to output convolution layer 1211, which may apply a 1×1 convolution with one filter to convert the shape (45×96×32) data to the final form of (45×96×1). The result may be processed by sigmoid block 1212, applying a sigmoid function to the data, and the result is the output of the neural network.

In other words, in the training stage, the network may predict from (64×96×1) size data an output data of size (45×96×1). The input was the spectral information, and the output comprises gains for each time and frequency at the data. In the inference, the input data time dimension may not be 64 but 20, providing output shape (1×96×1), i.e., 96 values.

The training may be performed by using two data sets of audio files: clean speech and various noises. In training, these data sets may be randomly mixed (speech and noise items selected randomly, and temporally cropped randomly) with random gains for each (thus having random speech-to-noise ratio). The mixture may be produced by summing these speech and noise signals produced this way. This approach may enable having the clean speech reference available. The network spectral input may be formulated based on the mixture, and the network may predict an output which may be used as the gains in each frequency band to process the mixture audio signals. Due to training, the network may then learn to predict meaningful such output or gain values.

More specifically, the above signals (mixture and speech) may comprise pulse code modulation (PCM) signals with a sampling rate of 48 kHz, which may be converted to time-frequency domain using a short-time Fourier transform (STFT) with a sine window, hop size of 960 samples, and FFT size of 1920 samples. This may result in a time-frequency signal having 961 unique frequency bins and 64 timesteps. The frequency bin data may then be converted to the first feature part of the neural network input data as described above. Furthermore, when processing the 961-bin mixture signal with the predicted gains (i.e., the network output) having 96 values, each f:th gain may be used to process the frequency bins at the range from b_{low}(f) to b_{high}(f) to obtain the output where non-speech signals are suppressed.

To guide the network training, it may be necessary to define a loss function that provides a value that defines how well the network is predicting the desired result. For the loss function, a difference signal may be formulated between a ground truth speech signal (i.e., the clean speech reference) and the gain-processed mixture. The loss function may formulate the energy of the difference signal with respect to the energy of the mixture in decibels. An Adam optimizer with a learning rate of 0.001 and batch size of 120 may be applied at the training.

Due to training, the network weights may converge, and they may then be provided to memory 204 of user device 200 for use.

It is also possible to train one machine learning model with a specific architecture, then derive another machine learning model from that using processes such as compilation, pruning, quantization or distillation. The term machine learning model covers also all these use cases and the outputs of them. The machine learning model may be executed using any suitable apparatus, for example CPU, GPU, ASIC, FPGA, compute-in-memory, analog, or digital, or optical apparatus. It is also possible to execute the machine learning model in an apparatus that combines features from any number of these, for instance digital-optical or analog-digital hybrids. In some examples, the weights and required computations in these systems may be programmed to correspond to the machine learning model. In some examples, the apparatus may be designed and manufactured so as to perform the task defined by the machine learning model so that the apparatus is configured to perform the task when it is manufactured without the apparatus being programmable as such.

In the following, an example of speech mask estimation in inference stage is described.

In the inference time, the network may be called once per frame to obtain a speech mask for a single temporal index, in contrast to the training stage where the speech mask may be obtained for multiple output steps per call.

Therefore, in the inference stage, the network input data I(n, f, c) may be otherwise as defined previously in the context of training the network, but with two differences: firstly, the network input time dimension may be 20, which provides output data for a single temporal frame, which is the most recent frame to be processed. During processing, the input data vector for the current frame n may be prepared (as described in the following), and the last 19 input data vectors may be obtained from memory, from processing of previous frames n.

Secondly, the normalization may not be performed over a sequence of 64 samples, but instead using a running average. Therefore, at least some of the following modifications may be needed to the formulas:

The max value E_{dB_max}(n) for the bottom limitation may be obtained by keeping the values E_{dB}(n,f) over the last 64 temporal indices (i.e., for range n−63, . . . , n), and selecting the largest of them. E′_{dB} (n, f) is formulated as described previously.

The mean may be formulated, e.g., by:

$${{E}^{′}}_{dB \_ mean} ( n ) = ( 1 - β ) \frac{1}{{N}_{f}} {\sum }_{f = 1}^{{N}_{f}} {{E}^{′}}_{dB} ( n , f ) + β {{E}^{′}}_{dB \_ mean} ( n - 1 )$$

where N_{f}=96; β is an IIR averaging factor, for example 0.99, and E′_{dB_mean}(0)=0.

The variance may be formulated, e.g., by:

$${{E}^{′}}_{dB \_ var} ( n ) = ( 1 - β ) \frac{1}{{N}_{f}} {\sum }_{f = 1}^{{N}_{f}} {[ {{E}^{′}}_{dB} ( n , f ) - {{E}^{′}}_{{dB}_{mean}} ( n ) ]}^{2} + β {{E}^{′}}_{dB \_ var} ( n - 1 )$$

The standard deviation may then be, e.g.:

$${{E}^{′}}_{dB \_ std} ( n ) = \sqrt{{{E}^{′}}_{dB \_ var} ( n )}$$

The network input feature data may then be, e.g.:

$$I ( n , f , 1 ) = \frac{{{E}^{′}}_{dB} ( n , f ) - {{E}^{′}}_{dB \_ mean} ( n )}{{{E}^{′}}_{dB \_ std} ( n )}$$

Otherwise, the generation of the network input data may be as in the training phase.

The functionality described herein can be performed, at least in part, by one or more computer program product components such as software components. According to an embodiment, user device 200 and/or user device 210 may comprise a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Tensor Processing Units (TPUs), and Graphics Processing Units (GPUs).

As used in this application, the term “circuitry” may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A user device, comprising:
at least one processor; and
at least one memory storing instructions that, when executed by the at least one processor, cause the user device at least to:
obtain at least two microphone signals representing spatial audio including at least intermittently audio content generated by at least one audio content source, the at least two microphone signals captured with at least two microphones;
separate, at least partly, the audio content generated by the at least one audio content source from the obtained at least two microphone signals;
determine direction information for the at least one audio content source, the direction information comprising information about a spatial direction which the audio content generated by the at least one audio content source originates from with respect to the at least two microphones; and
perform one or more processing tasks based on the separated audio content and the determined direction information to generate an encoded spatial audio bit stream.

2. The user device according to claim 1, wherein the one or more processing tasks comprise generating one or more audio objects from the separated audio content based on the determined direction information, each audio object comprising an audio signal with at least one of an associated direction parameter or an associated position parameter.

3. The user device according to claim 1, wherein the one or more processing tasks further comprise generating an auxiliary spatial audio bit stream from the obtained at least two microphone signals substantially without the audio content.

4. The user device according to claim 3, wherein the auxiliary spatial audio bit stream comprises a metadata-assisted spatial audio, MASA, stream.

5. The user device according to claim 3, wherein the one or more processing tasks further comprise generating the spatial audio bit stream based on the generated auxiliary audio bit stream and the generated one or more audio objects.

6. The user device according to claim 5, wherein the spatial audio bit stream comprises an objects with metadata-assisted spatial audio, OMASA, stream.

7. The user device according to claim 5, wherein the one or more processing tasks further comprise encoding the generated spatial audio bit stream with one or more audio signals of at least one audio object of the generated one or more audio objects encoded separately from one or more audio signals of the generated auxiliary audio bit stream.

8. The user device according to claim 7, wherein the encoding of the generated spatial audio bit stream comprises adaptively adjusting a bit allocation within the generated spatial audio bit stream between the at least one audio object of the generated one or more audio objects and the generated auxiliary audio bit stream.

9. The user device according to claim 1, wherein the separation of the audio content comprises estimating a speech time-frequency signal having multiple channels comprising the audio content.

10. The user device according to claim 1, wherein the separation of the audio content further comprises estimating a speech time-frequency signal having a single channel comprising the audio content.

11. The user device according to claim 10, wherein the separation of the audio content further comprises estimating speech steering data indicating an estimated response of the audio content to the at least two microphones.

12. The user device according to claim 11, wherein the separation of the audio content further comprises estimating a microphone time-frequency signal with speech removed representing a remainder signal without the audio content.

13. The user device according to claim 11, wherein the determination of the direction information is performed based on the estimated speech time-frequency signal and the estimated speech steering data.

14. The user device according to claim 1, wherein the information about the spatial direction comprises at least one of direction of arrival, DOA, information of the spatial direction or a direct-to-total energy ratio of the spatial direction, the direct-to-total energy ratio indicating how much of the energy in a frequency resource is directional energy coming from the spatial direction.

15. The user device according to claim 14, wherein the determination of the direction information comprises temporal averaging of at least energy-weighted sums of the DOA information over multiple frequencies.

16. The user device according to claim 1, wherein the audio content comprises speech.

17. A method, comprising:
obtaining, by a user device, at least two microphone signals representing spatial audio including at least intermittently audio content generated by at least one audio content source, the at least two microphone signals captured with at least two microphones;
separating, by the user device, at least partly the audio content generated by the at least one audio content source from the obtained at least two microphone signals;
determining, by the user device, direction information for the at least one audio content source, the direction information comprising information about a spatial direction which the audio content generated by the at least one audio content source originates from with respect to the at least two microphones; and
performing, by the user device, one or more processing tasks based on the separated audio content and the determined direction information to generate an encoded spatial audio bit stream.

18. A computer program comprising instructions for causing a user device to perform at least the following:
obtaining at least two microphone signals representing spatial audio including at least intermittently audio content generated by at least one audio content source, the at least two microphone signals captured with at least two microphones;
separating, at least partly, the audio content generated by the at least one audio content source from the obtained at least two microphone signals;
determining direction information for the at least one audio content source, the direction information comprising information about a spatial direction which the audio content generated by the at least one audio content source originates from with respect to the at least two microphones; and
performing one or more processing tasks based on the separated audio content and the determined direction information to generate an encoded spatial audio bit stream.
